(19) United States
(12) Patent Application Publication
(10) Pub. No.: US 2022/0030889 A1
(43) Pub. Date: Feb. 3, 2022

(54) FOOD PRODUCT AND METHOD OF PREPARATION

(71) Applicant: Trinity Groves Restaurant Incubator Partners, LP., Dallas, TX (US)

(72) Inventors: Philip J. Romano, Dallas, TX (US); Jay Valley, Dallas, TX (US)

(21) Appl. No.: 17/390,741

(22) Filed: Jul. 30, 2021

Related U.S. Application Data
(60) Provisional application No. 63/059,624, filed on Jul. 31, 2020.

(51) Int. Cl. A21D 13/41; A21D 2/16; A21D 13/22; A21D 13/24; A21D 13/28; A21D 13/04

(52) U.S. Cl. CPC A21D 13/41; A21D 2/165; A21D 13/04; A21D 13/24; A21D 13/28; A21D 13/22

(57) ABSTRACT

A food product is prepared by completely baking a base and spreading a separately sautéed topping mixture thereover just prior to serving. The base or “crust” includes a bread dough on which oil is drizzled and cheese fragments are spread prior to baking to a preparation completion point. Concurrent with baking of the base, a topping mixture is sautéed, preferably timed to be completed at the same time as the base is fully baked, and is spread on the completely baked base. After optionally being garnished, the resulting food product is promptly served.

### CROSS-REFERENCE TO RELATED APPLICATION AND PRIORITY CLAIM

This application claims priority under 35 U.S.C. § 119(e) to U.S. Provisional Patent Application No. 63/059,624 filed on Jul. 31, 2020, which is hereby incorporated by reference in its entirety.

### TECHNICAL FIELD

This disclosure relates generally to preparation of food products and, more specifically, to methods for preparing a pizza-type food product.

### BACKGROUND

Within the competitive restaurant and food-service industries, consumers seek novel dining experiences and food choices. Among the numerous types of food products and cuisines, pizza—an oven-baked, flat, disk-shaped bread (or, equivalently, “crust”) typically topped with a tomato sauce, cheese (usually mozzarella), and various meat, vegetable and/or fruit toppings—is a perennially popular choice.

### SUMMARY

This disclosure provides methods and for preparing food products and the food products thereby formed.

In a first embodiment, a food product is prepared by completely baking a base and spreading a separately sautéed topping mixture thereover just prior to serving. The base or “crust” includes a bread dough on which oil is drizzled and cheese fragments are spread prior to baking to a preparation completion point. Concurrent with baking of the base, a topping mixture is sautéed, preferably timed to be completed at the same time as the base is fully baked, and is spread on the completely baked base. After optionally being garnished, the resulting food product is promptly served.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Definitions for other certain words and phrases may be provided in this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIGS. 1A-1D illustrates cross-sections of intermediate and completed food products at various stages during preparation of a food product in accordance with this disclosure;

FIG. 2 depicts a highly level flow diagram for a process of preparing a food product in accordance with this disclosure; and

FIGS. 3A and 3B illustrate various items of equipment used in preparing a food product in accordance with this disclosure.

### DETAILED DESCRIPTION

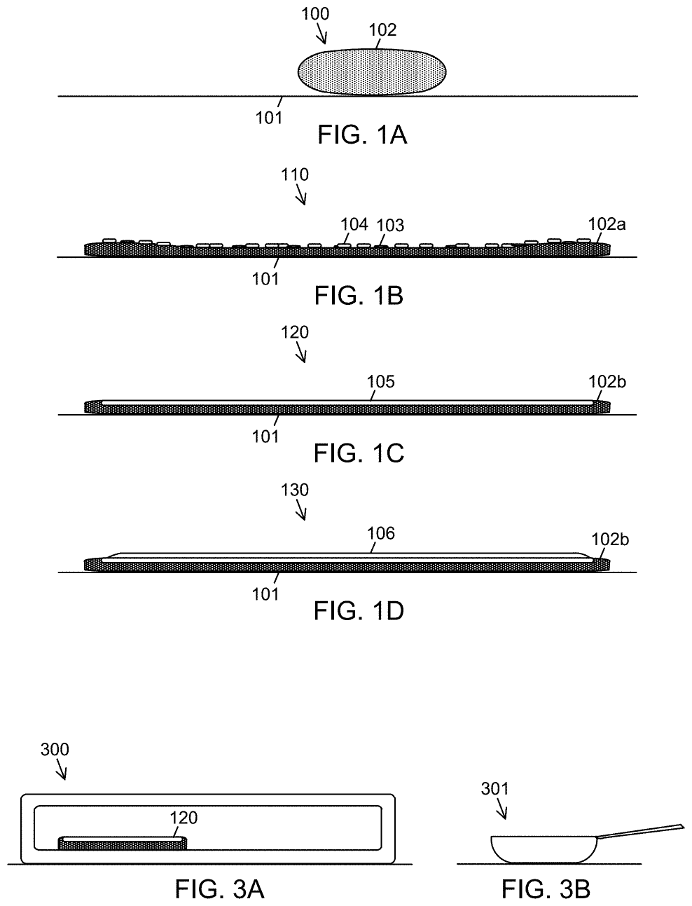

FIGS. 1A through 3B, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged device or system.

This disclosure describes various methods for preparing pizza, flatbread and similar food products (generally, “pizza-type” food products) and the food products that are formed thereby. These are for illustration only and represent exemplary ways in which a pizza-type food product can be prepared in accordance with this disclosure.

In the present disclosure, a pizza is prepared from a completely baked base on which a sautéed topping mixture is spread. The base includes a bread dough or “crust” formed from at least flour and water, and typically (but not necessarily) also yeast or another leavening agent and salt. The bread dough is shaped into a roughly circular disk (or squat cylinder). Oil is applied to at least portions of an upper surface of the shaped bread dough, typically by drizzling. Cheese fragments are spread on top of the shaped bread dough, preferably over the oil (where present). The assembled base—bread dough, oil and cheese fragments—is then baked in an oven at a suitable temperature to a preparation completion point.

Concurrent with preparation of the completely baked base, a topping mixture is sautéed, preferably timed to be ready at about the same time as the completely baked base is removed from the oven. The sautéed topping mixture is spread on the completely baked base, and the resulting food product is, after optionally being garnished, promptly served.

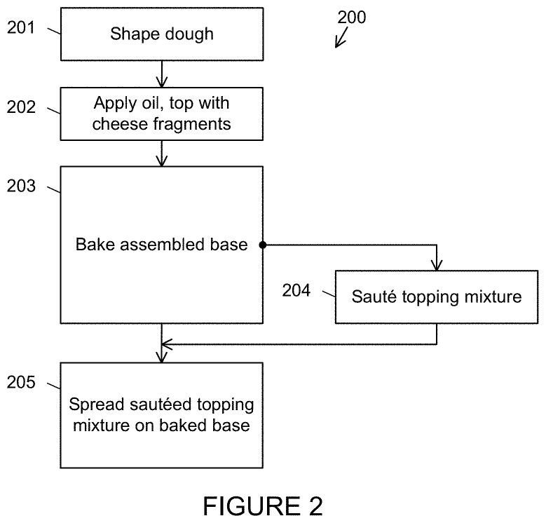

FIGS. 1A through 1D diagrams illustrating cross-sections of intermediate and completed food products at various stages during preparation of a food product in accordance with the present disclosure. FIG. 2 depicts a highly level flow diagram for a process 200 of preparing a food product in accordance with the present disclosure. FIGS. 3A and 3B illustrate various items of equipment used in preparing a food product in accordance with the present disclosure. For clarity and simplicity, these figures are described in conjunction with each other.

FIG. 1A depicts an initial portion of the food product base used in preparation of a food product in accordance with the present disclosure. The initial food product base 100 is placed on a food preparation surface 101. The initial food product base 100 is a bread-type dough 102 formed from at least flour (normally finely ground wheat or another grain; alternatively cauliflower flour or the like) and water, and typically (but not necessarily) also yeast or another leavening agent (e.g., baking soda or baking powder) and salt. Other constituents may be included within the initial food product base 100.

The dough 102 for the initial food product base 100 is shaped, preferably by hand, into a shaped dough 102a (step 201 of FIG. 2). Alternatively, the shaping of the initial food product base 100 may be automated through use of a dough roller of the type known in the art. The shaped dough 102a has the form of a roughly circular disk or squat cylinder that is preferably at least about 10 inches in diameter (i.e., large enough to substantially fill a standard 10.5 inch dinner plate) up to about 14 to 18 inches in diameter. The dough 102 will typically be somewhat compressed during shaping into the shaped dough 102a, increasing the density of the shaped dough 102a relative to the dough 102 for the initial food product base 100. The shaped dough 102a may be allowed to re-rise for a period of time after being shaped. The thickness of the shaped dough 102a may be relatively thin (e.g., ¼ inch to ½ inch thick—that is, a New York-style pizza crust that is thick and crisp only along the edge and remains soft, thin, and sufficiently pliable—even after baking and beneath any toppings—to be folded in half to eat). Alternatively, the thickness of the shaped dough 102a may be relatively thick (i.e., 1 inch or more—that is, “deep-dish” style pizza). As is typical for pizza crusts, the thickness profile of the shaped dough 102a may be irregular, and is preferably thinner in a central area than at the periphery, creating a shallow dish for the toppings. After shaping, the shaped dough 102a has the approximate form illustrated in FIG. 1B.

Oil 103 is applied to at least portions of an upper surface of the shaped dough 102a and cheese fragments 104 are spread on top of the shaped dough 102a (step 202 of FIG. 2). The oil 103 may be applied by drizzling, but alternatively may be spread on the shaped dough 102a by brush or similar mechanism or by an automated dispenser or the like at the outlet of a dough roller. The oil 103 may be extra virgin olive oil. The oil contributes to formation of crisp, firm or otherwise slightly hard dough surfaces during baking while leaving interior portions of the dough generally pliable. The cheese fragments 104 are preferably spread over the oil (where present), either by hand or using an automated dispenser also at the outlet of a dough roller. The cheese fragments 104 preferably include at least shredded parmesan cheese flakes or grated parmesan cheese particles, together with shredded, grated, or finely cubed mozzarella cheese. Additional other cheese(s) and/or fragments having different forms besides shredded or grated cheese or cubed cheese may also be included in the cheese fragments 104. The cheese fragments 104 may alternatively comprise only one of parmesan cheese or mozzarella cheese, alone or optionally together with additional other cheese(s). In some embodiments, some of the cheese fragments 104 may be densely placed along a circle near a periphery of the shaped dough 102a and the edge of the shaped dough 102a folded over and around those cheese fragments, then pinched closed to form a “stuffed crust.” Optionally, seasonings such as salt and pepper may be sprinkled on the surface of shaped dough 102a after the oil 103 is applied and the cheese fragments 104 are spread. In some embodiments, additional other toppings (e.g., pepperoni) may be placed or spread on the upper surface of the shaped dough 102a. The result of steps 201-202 in FIG. 2 is an assembled food product base 110 as depicted in FIG. 1B.

The assembled food product base 110—(at least) shaped dough 102a, oil 103 and cheese fragments 104—is then baked (step 203 in FIG. 2) in an oven 300 at a suitable temperature to a preparation completion point (typically, about 8-10 minutes at a temperature ranging from 400° Fahrenheit (F) to 500° F.). Transfer of the assembled food product base 110 may be by hand or on a conveyor from a dough roller. As used herein, “preparation completion point,” when used in conjunction with the assembled food product base 110 or to describe the baked food product base 120 depicted in FIG. 1C, refers to a fully baked food product suitable for being served without further baking, heating, etc. However, those skilled in the art will understand that the baked food product base 120 may, for a brief period prior to being served, be subsequently placed under heat lamps or within another suitable food warming mechanism. At the preparation completion point, the baked dough 102b will typically have a golden-brown color and have slightly crisp or firm surfaces with a soft, pliable internal region, as is common with pizza crusts. The oil 103 and cheese fragments 104 will preferably have formed, as a result of baking, a blended coating 105 over a central region of the baked dough 102b, with the cheeses melted together. In fact, when removed from the oven, the baked food product base 120 depicted in FIG. 1C is essentially a plain cheese pizza (without sauce) or cheesy flat bread, and may be served as such with olive oil (or olive oil with balsamic vinegar) or marinara sauce for dipping.

Concurrent with oven baking of the baked food product base 120, a topping mixture is sautéed (step 204 in FIG. 2) in a sauté pan 301. Sautéing of the topping mixture is preferably timed to be completed at about the same time as the baked food product base 120 is removed from the oven. Timing may be automated based on detection of the assembled food product base 110 into the oven, either causing a signal to a person preparing the topping mixture or by automated release of topping mixture ingredients into a sauté pan. The sautéed topping mixture 106 is spread on the baked food product base 120 (step 205 in FIG. 2), in a generally even coating or spread as depicted in FIG. 1D, either by hand or automated delivery from the sauté pan. The resulting completed food product 130 depicted in FIG. 1D is, after optionally being garnished, promptly served (i.e., within a few minutes). Various alternatives for sautéed topping mixtures 106 are described in further detail below. As noted below, the sautéed topping mixture 106 may actually comprise a plurality of topping mixtures that are separately sautéed and spread sequentially on the surface of the food product base 120.

The process of forming a food product described above results in several beneficial characteristics of the completed food product 130. First, baking of the “crust” (assembled food product base 110 comprising substantially only shaped dough 102a, oil 103 and cheese fragments 104) allows the oil 103 and the melting of the cheese fragments 104 to contribute to forming a structurally stronger “crust” than baking with traditional pizza ingredients (e.g., sauce) already spread on the “crust.” While slices remain flexible enough to fold for eating, the difference in structural rigidity for the “crust” allows a greater assortment of topping mixtures to be spread in forming the completed food product 130. In addition, baking of the “crust” prior to applying or spreading any constituents—other than the oil 103—including significantly liquid compositions (e.g., sauce) on the crust alters the manner in which the liquids seep into the “crust.” That is, liquids seep or diffuse under the force of gravity into the baked food product base 120 differently that into the shaped dough 102a of the (unbaked) assembled food product base 110. As a result, the “crust” is less likely to be soggy or moist when served promptly after spreading of the sautéed topping mixture 106, although such a result becomes more likely as time passes following the spreading of the sautéed topping mixture 106. As a result, the initial difference between preparation of the food product in the manner described herein and traditional methods of preparing pizza does not meaningfully impact the desirable characteristics (e.g., diffusion of liquids from the sauce into the dough) of “leftover” or “cold” pizza after a significant period of time passes.

The process of forming a food product described herein is also well-suited to commercial implementation. For example, the food preparation surface 101 and/or the oven 300 may be located at one station within a kitchen, and the sauté pan 301 located at a second station, with the baked food product base 120 transferred from the first station to the second station for completion of the food product prior to serving. Alternatively, a third station may be used for spreading the sautéed topping mixture 106 on the baked food product base 120 and garnishing prior to the food product being served. The assembled food product base 110 and/or the baked food product base 120 may be the same, regardless of the composition of the sautéed topping mixture 106. Alternatively, one or both of the assembled food product base 110 and/or the baked food product base 120 may utilize ingredients specific and complementary to the composition of the sautéed topping mixture 106.

The sautéed topping mixture 106 spread on the baked food product base 120 may include permutations of many traditional pizza toppings: onions; bell peppers or other types of peppers; mushrooms; green and/or black olives; ground meat (e.g., sausage or beef); ham, bacon, and/or Canadian bacon; or pineapple. Moreover, additional cheese(s) may be included within the sautéed topping mixture 106 and melted before that mixture is spread on the baked food product base 120. Sauce or tomato product may be included in the sautéed topping mixture 106, or tomatoes (with appropriate seasonings) may be separately sautéed from a sautéed topping mixture of meats and vegetables and spread last, for a Chicago-style pizza. Further, some of the foregoing ingredients (alone or in combination) may be spread on the surface of the baked food product base 120 as a garnish either before or after the sautéed topping mixture 106 is spread, or some before and some after. Such garnishes need not be sautéed or otherwise cooked, such as grated parmesan cheese, dried crushed red pepper flakes, dried oregano leaves, and/or chopped fresh Italian parsley leaves.

The food product preparation method described herein also allows a wide array of non-traditional topping mixtures to be used as the sautéed topping mixture 106, including for example:
a sautéed chicken alfredo mixture;
a sautéed veal picatta mixture;
a sautéed shrimp fra diavolo mixture; and
a sautéed sausage and peppers mixture.
   Other non-traditional alternatives include a cheeseburger topping mixture (e.g., ground beef) that may be garnished with mustard, ketchup and chopped pickles (relish).

Although this disclosure has been described with an exemplary embodiment, various changes and modifications may be suggested to one skilled in the art. It is intended that this disclosure encompass such changes and modifications as fall within the scope of the appended claims.

What is claimed is:

1. A method of preparing a food product, the method comprising:
forming an assembled food product base by:
shaping a bread dough portion of a food product base,
applying oil on at least portions of an upper surface of the shaped bread dough portion, and
topping the shaped bread dough portion with at least one type of cheese fragments;
baking the assembled food product base to a preparation completion point for the food product base to form a baked food product base;
concurrent with baking the assembled food product base, sautéing a topping mixture; and
spreading the sautéed topping mixture on an upper surface of the baked food product base to form a complete food product.

2. The method of claim 1, wherein the oil is an only non-solid food product that is applied prior to baking the food product base.

3. The method of claim 1, wherein the food product base is baked without a sauce.

4. The method of claim 1, further comprising:
adding a garnish to the baked food product base prior to spreading the sautéed topping mixture.

5. The method of claim 4, further comprising:
adding a second garnish after the sautéed topping mixture after being spread on the baked food product base.

6. The method of claim 5, wherein adding the second garnish includes melting an additional cheese prior to adding to the sautéed topping mixture.

7. The method of claim 4, wherein adding the garnish includes melting an additional cheese to the garnish, the additional cheese is melted prior to adding the baked food product base.

8. The method of claim 1, further comprising:
adding a garnish to the complete food product.

9. The method of claim 8, wherein the garnish includes a plurality of topping mixtures that are separately sautéed and spread sequentially on a surface of the food product base.

10. The method of claim 1, wherein baking the assembled food product base includes baking the assembled food product base at a temperature range from 400° Fahrenheit (F) to 500° F.

11. The method of claim 10, wherein baking the assembled food product base includes backing the assembled food product base for 8-10 minutes at the temperature range.

12. The method of claim 1, wherein topping the shaped bread dough portion with at least one type of cheese fragments further includes densely placing the at least one type of cheese fragments along a circle near a periphery of the shaped bread dough portion.

13. The method of claim 12, further comprising:
folding an edge of the shaped bread dough portion over the at least one type of cheese fragments.

14. The method of claim 1, wherein the food product base is made of cauliflower flour.

15. The method of claim 1, further comprising:
serving the complete food product promptly after spreading the sautéed topping mixture on the upper surface of the baked food product base.

16. A complete food product, the complete food product comprising:
an assembled food product base baked to a preparation completion point for a food product base to form a baked food product base, the assembled food product base includes:
a bread dough portion shaped as the food product base,
oil applied on at least portions of an upper surface of the shaped bread dough portion, and
at least one type of cheese fragments topped on the shaped bread dough portion; and
a sautéed topping mixture spread on an upper surface of the baked food product base, the sautéed topping mixture spread is sautéed concurrently with baking the assembled food product base.

17. The complete food product of claim 16, wherein the oil is an only non-solid food product that is applied prior to baking the food product base.

18. The complete food product of claim 1, further comprising:
an additional cheese added as a garnish to the baked food product base after the sautéed topping mixture after being spread on the baked food product base.

19. The complete food product of claim 8, further comprising:
a plurality of topping mixtures that are separately sautéed and spread sequentially on a surface of the food product base.

20. The complete food product of claim 16, further comprising:
at least one type of cheese fragments densely placed along a circle near a periphery of the shaped bread dough portion,
wherein an edge of the shaped bread dough portion is folded over the at least one type of cheese fragments.
